(19) United States
(12) Patent Application Publication
(10) Pub. No.: US 2024/0294016 A1
(43) Pub. Date: Sep. 5, 2024

(54) IMAGE FORMING APPARATUS

(71) Applicant: KYOCERA Document Solutions Inc., Osaka (JP)

(72) Inventors: Hiroomi Nakatsuji, Osaka (JP); Jun Nakano, Osaka (JP); Masato Usui, Osaka (JP); Naoko Kawashima, Osaka (JP)

(21) Appl. No.: 18/585,621

(22) Filed: Feb. 23, 2024

(30) Foreign Application Priority Data
Mar. 2, 2023 (JP) 2023-031726

(51) Int. Cl. B41J 2/21

(52) U.S. Cl. CPC B41J 2/2142; B41J 2/2135; B41J 2/2139

(57) ABSTRACT

An ejection malfunction nozzle detecting unit prints a test pattern and detects ejection malfunction nozzles on the basis of a scanned image of the test pattern. The ejection malfunction nozzle detecting unit classifies the ejection malfunction nozzles into periodical nozzles that periodically appear with a specific period in a primary scanning direction and non-periodical nozzles other than the periodical nozzles; for the periodical nozzles, stores the specific period and an offset as the ejection malfunction nozzle data into a storage device, and for the non-periodical nozzles, stores the ejection malfunction nozzle data that individually indicates positions of the non-periodical nozzles into the storage device. A correction processing unit performs the correction process for the periodical nozzles on the basis of the specific period and the offset, and the correction process for the non-periodical nozzles on the basis of the positions of the non-periodical nozzles.

### CROSS-REFERENCE TO RELATED APPLICATIONS

This application relates to and claims priority rights from Japanese Patent Application No. 2023-031726, filed on Mar. 2, 2023, the entire disclosures of which are hereby incorporated by reference herein.

### BACKGROUND

### 1. Field of the Present Disclosure

The present disclosure relates to an image forming apparatus.

### 2. Description of the Related Art

An inkjet image forming apparatus prints a test pattern using a recording head; on the basis of an image of the printed test pattern, detects an ejection malfunction nozzle that can not properly eject ink among nozzles that eject ink in the recording head; and increases an ink amount of an adjacent dot.

Another inkjet image forming apparatus determines a spatial frequency of a slight initial deviation (a deviation of an ejection amount and an ejection direction of an ink droplet) due to manufacture precision, excludes the spatial frequency of the slight initial deviation in a frequency spectrum of a density distribution of an image of the test pattern and thereby generates a correction distribution, and detects an ejection malfunction nozzle except for a nozzle of the initial deviation on the basis of the correction distribution.

However, in the aforementioned image forming apparatus, even if a periodical ejection malfunction nozzles occur such that the periodical ejection malfunction nozzles affect image quality, rather than the initial deviation, detection of such periodical ejection malfunction nozzles and a correction process (ejection amount adjustment for a surrounding nozzle of the ejection malfunction nozzles) are not properly performed.

### SUMMARY

An image forming apparatus according to an aspect of the present disclosure includes a recording head, a control unit, an ejection malfunction nozzle detecting unit, a storage device, and a correction processing unit. The recording head is configured to eject ink corresponding to an image to be printed, using arranged nozzles. The control unit is configured to determine nozzles corresponding to the image to be printed, correspondingly to a position of a print sheet, and cause the recording head to eject ink from the nozzles. The ejection malfunction nozzle detecting unit is configured to (a) print a test pattern on a print sheet using the recording head, and (b) detect ejection malfunction nozzles on the basis of a scanned image of the test pattern. The storage device is configured to store ejection malfunction nozzle data that indicates the detected ejection malfunction nozzles. The correction processing unit is configured to perform a correction process corresponding to the ejection malfunction nozzles on the basis of the ejection malfunction nozzle data. Further, the ejection malfunction nozzle detecting unit (a) classifies the ejection malfunction nozzles into periodical nozzles that periodically appear with a specific period in a primary scanning direction and non-periodical nozzles other than the periodical nozzles, (b1) for the periodical nozzles, stores the specific period and an offset as the ejection malfunction nozzle data into the storage device, and (b2) for the non-periodical nozzles, stores the ejection malfunction nozzle data that individually indicates positions of the non-periodical nozzles into the storage device; and the correction processing unit performs the correction process for the periodical nozzles on the basis of the specific period and the offset in the ejection malfunction nozzle data, and performs the correction process for the non-periodical nozzles on the basis of the positions of the non-periodical nozzles in the ejection malfunction nozzle data.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a block diagram that indicates an electronic configuration of the image forming apparatus 10 in the embodiment according to the present disclosure;

FIG. 4 shows a flowchart that explains a behavior of the image forming apparatus 10 shown in FIGS. 1 to 3;

FIG. 5 shows a diagram that indicates an example of a test pattern scanned image;

FIG. 6 shows a diagram that explains detection of an ejection malfunction nozzle on the basis of a density distribution (brightness distribution) of the test pattern scanned image shown in FIG. 5; and

FIG. 7 shows a diagram that explains classification of the ejection malfunction nozzles shown in FIG. 6 into periodical nozzles and non-periodical nozzles.

### DETAILED DESCRIPTION

Hereinafter, an embodiment according to an aspect of the present disclosure will be explained with reference to drawings.

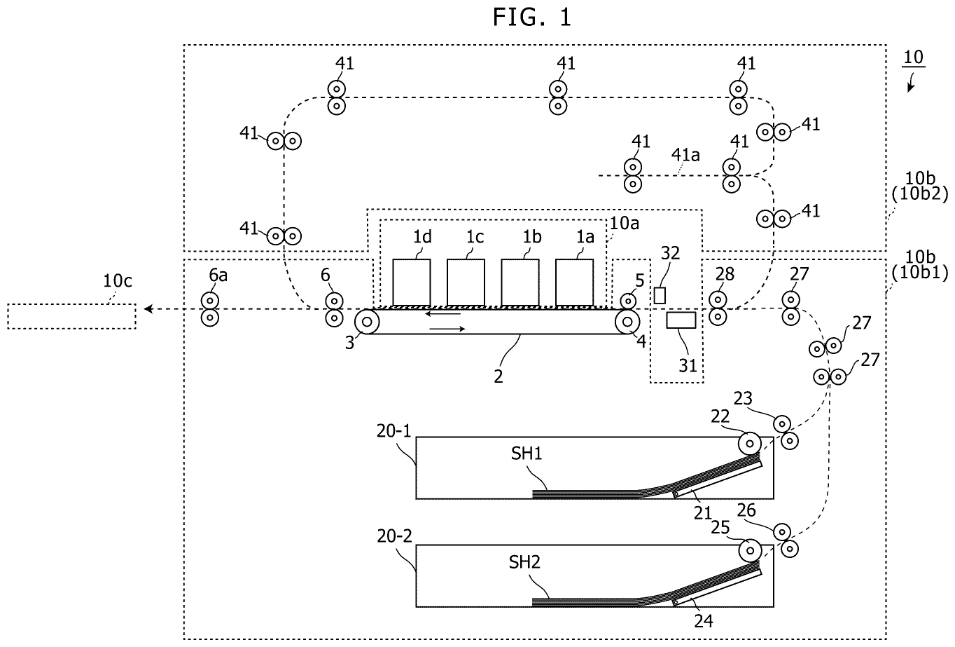

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type head units 1a to 1d corresponding to four ink colors: Cyan, Magenta, Yellow, and Black.

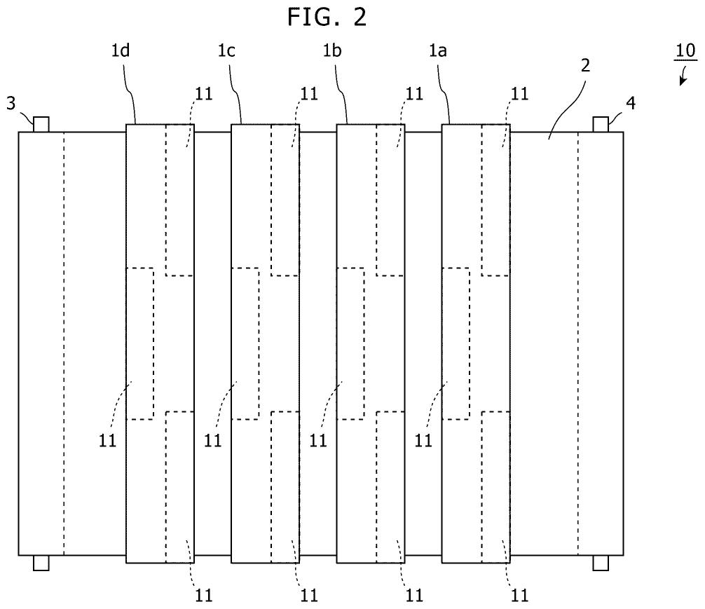

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11. The head unit 11 of the recording head 1a, 1b, 1c or 1d includes plural nozzles arranged 2-dimensionally; plural pressure chambers that are connected to the plural nozzles respectively and to which ink is supplied; and plural piezoelectricity actuators that are installed in the pressure chambers, are driven by a driving signal corresponding to image data of an image to be printed and pushes ink from the pressure chambers to the nozzles and thereby cause the nozzles to eject ink; and ejects ink corresponding to the image to be printed from the nozzles.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a top end of the print sheet SH1 or SH2 passes through a predetermined position on the transportation path. The line sensor 31 detects the positions of the both side end edges at a time point that the top end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

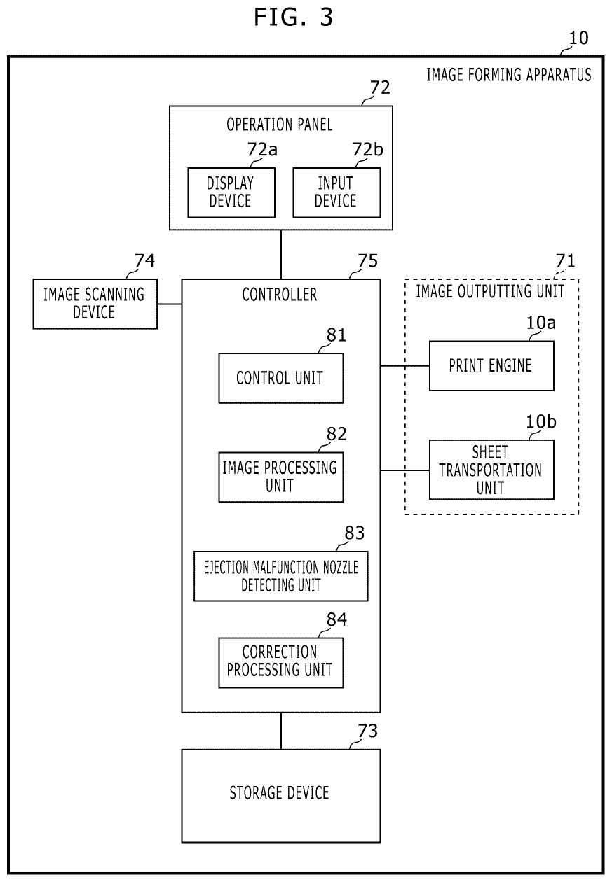

FIG. 3 shows a block diagram that indicates an electronic configuration of the image forming apparatus 10 in the embodiment according to the present disclosure. As shown in FIG. 3, the image forming apparatus 10 includes not only an image outputting unit 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10. In the storage device 73, ejection malfunction nozzle data mentioned below is stored.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, an ejection malfunction nozzle detecting unit 83, and a correction processing unit 84.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. Specifically, the control unit 81 supplies a driving signal to each of the piezoelectricity actuators in the head unit 11 and thereby causes to eject ink from the nozzles. The image processing unit 82 performs a predetermined image process such as RIP (Raster Image Processing), color conversion, halftoning and/or the like for image data of a printing image.

As mentioned, the control unit 81 causes the print engine 10a to print a user document image based on printing image data specified by a user.

In this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process. Specifically, in the automatic centering function, the control unit 81 changes a depicting position of the image to be printed, in a primary scanning direction by a difference between a reference center position of the print engine 10a and the actual sheet center position. In this embodiment, because the nozzles of the recording heads 1a to 1d do not move, a nozzle corresponding to each pixel in the image to be printed is changed correspondingly to the depicting position of the image to be printed.

As mentioned, the control unit 81 determines nozzles corresponding to the image to be printed (a nozzle corresponding to each pixel), correspondingly to a position of a print sheet, and causes the recording heads 1a to 1d to eject ink from the determined nozzles.

Using the control unit 81, the ejection malfunction nozzle detecting unit 83 (a) prints a test pattern on a print sheet using the recording heads 1a to 1d, and (b) detects an ejection malfunction nozzle (i.e. a nozzle of which non ejection, ejection deviation (deviation of an ink droplet hitting position or the like occurs) on the basis of a scanned image of the test pattern. The test pattern is individually printed for each of the ink colors. The test pattern is a band-shaped image along a primary scanning direction with a single density (an intermediate gradation level or a maximum density in FM screen, AM screen or the like); a density defect position (a position of a blank line) is determined in a density distribution of the primary scanning direction in the scanned image of the test pattern; and a nozzle corresponding to the density defect position is determined as the ejection malfunction nozzle. The nozzle corresponding to the density defect position is determined in accordance with an existent method.

In this embodiment, because the line sensor 31 is installed to detect a position of a print sheet, for example, the aforementioned test pattern is printed on the print sheet, the circulation transportation unit 10b2 transports the print sheet, the line sensor 31 scans an image of the printed test pattern.

If the line sensor 31 is used for the detection of the ink ejection malfunction positions as mentioned, the ink ejection malfunction positions are automatically detected, and the print sheet on which the test pattern has been printed is outputted. Instead of the line sensor 31, the print sheet on which the test pattern has been printed may be immediately outputted and set on the image scanning device 74 by a user, and the image on the print sheet may be scanned by the image scanning device 74.

Further, the ejection malfunction nozzle detecting unit 83 (a) classifies the detected ejection malfunction nozzles into periodical nozzles that periodically appear with a specific period in the primary scanning direction and non-periodical nozzles other than the periodical nozzles, (b1) for the periodical nozzles, stores the specific period and an offset as the ejection malfunction nozzle data into the storage device 73, and (b2) for the non-periodical nozzles, stores the ejection malfunction nozzle data that individually indicates positions of the non-periodical nozzles into the storage device 73. Thus, data that individually indicates positions of the periodical nozzles (nozzle numbers or the like) is not stored in the storage device 73, and therefore small storage capacity is sufficient of the storage device 73.

It should be noted that periodical ejection malfunction nozzles are due to a structure, installation precision or the like of the head unit 11, and may occur over time. Further, in each of image forming apparatuses, appearance positions of such periodical ejection malfunction nozzles may be different from ones in another image forming apparatus.

For example, the ejection malfunction nozzle detecting unit 83 determines the periodical nozzles such that plural nozzles specified by the specific period and the offset include a predetermined rate or more of the periodical nozzles. In other words, such plural nozzles specified by the specific period and the offset may include a nozzle other than the ejection malfunction nozzles.

Further, for example, the ejection malfunction nozzle detecting unit 83 determines a specific period from a frequency spectrum of a density distribution obtained using Fourier transformation, determines the number (or a ratio) of the ejection malfunction nozzles specified by the specific period for each offset while the offset is changed in a predetermined range, and selects the offset such that the number (or the ratio) gets equal to or larger than a predetermined threshold value (or gets the largest).

It should be noted that individually for each of the recording head 1a to 1d (i.e. for each ink color), ejection malfunction nozzles are determined as targets of the correction process as mentioned.

The correction processing unit 84 reads the ejection malfunction nozzle data from the storage device 73, determines plural ejection malfunction nozzles on the basis of the ejection malfunction nozzle data, and in an image to be printed, performs a correction process corresponding to the determined plural ejection malfunction nozzles.

The correction process sets the ejection malfunction nozzles to be non ejection, and increases ink ejection amounts to a predetermined amounts of nozzles of ejection positions adjacent to ejection positions of the ejection malfunction nozzles. Specifically, in the correction process, pixels corresponding to the ejection malfunction nozzles are determined in an image to be printed, and pixel values of the pixels are changed to values corresponding to non ejection or the increased ink ejection amounts.

Specifically, the correction processing unit 84 performs the correction process for the periodical nozzles on the basis of the specific period and the offset in the ejection malfunction nozzle data, and performs the correction process for the non-periodical nozzles on the basis of the positions of the non-periodical nozzles in the ejection malfunction nozzle data.

In this process, the correction processing unit 84 performs the correction process for plural nozzles specified by the specific period and the offset regardless of whether the plural nozzles specified by the specific period and the offset include a nozzle other than the ejection malfunction nozzles or not, and thereby performs the correction process for the periodical nozzles. Thus, the correction processing unit 84 performs the correction process for plural nozzles specified by the specific period and the offset without excluding a nozzle other than the ejection malfunction nozzles in the plural nozzles specified by the specific period and the offset.

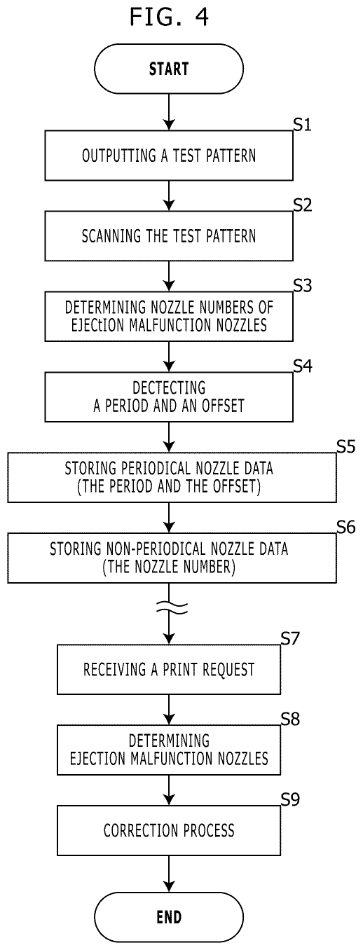

The following part explains a behavior of the image forming apparatus 10. FIG. 4 shows a flowchart that explains a behavior of the image forming apparatus 10 shown in FIGS. 1 to 3.

Using the control unit 81, the ejection malfunction nozzle detecting unit 83 causes the image outputting unit 71 to print the aforementioned test pattern on a print sheet (in Step S1), and acquires a scanned image of the test pattern using the line sensor 31 or the image scanning device 74 as mentioned (in Step S2).

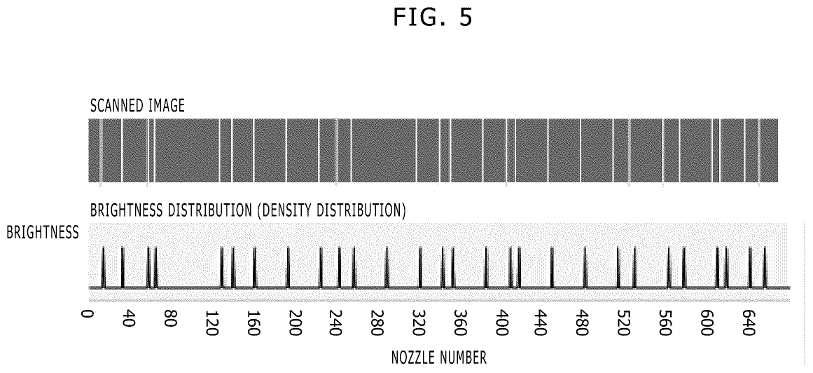

FIG. 5 shows a diagram that indicates an example of a test pattern scanned image. If ejection malfunction nozzles occur, then as shown in FIG. 5, for example, density defects appear in the test pattern scanned image.

Subsequently, the ejection malfunction nozzle detecting unit 83 determines density defect positions of the primary scanning direction in the test pattern scanned image, and determines nozzles numbers of the ejection malfunction nozzles on the basis of the density defect positions (in Step S3).

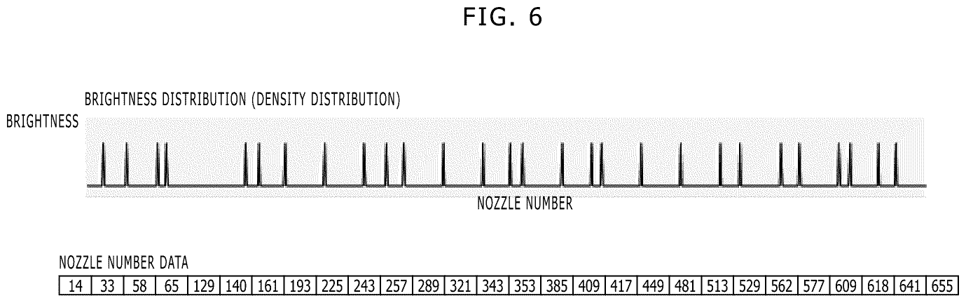

FIG. 6 shows a diagram that explains detection of an ejection malfunction nozzle on the basis of a density distribution (brightness distribution) of the test pattern scanned image shown in FIG. 5. As shown in FIG. 5, for example, if a density defect occurs in the test pattern scanned image, then in a density distribution a dip appears at a density defect position in the primary scanning direction of the test pattern scanned image (a peak appears in a brightness distribution as shown in FIG. 6, for example). For example, the test pattern scanned image is binarized, such dips or peaks are detected in the binarized test pattern scanned image, and nozzle numbers corresponding to pixel positions of the dips or the peaks are determined as nozzle numbers of eject malfunction nozzles.

Upon detecting the eject malfunction nozzles as mentioned, the ejection malfunction nozzle detecting unit 83 performs a frequency analysis and thereby determines a specific period and an offset of the eject malfunction nozzles, and classifies the eject malfunction nozzles into periodical nozzles and non-periodical nozzles on the basis of the specific period and the offset (in Step S4). It should be noted that plural specific periods and offsets may be determined, periodical nozzles corresponding to the specific periods and the offsets may be determined, and the aforementioned classification may be performed.

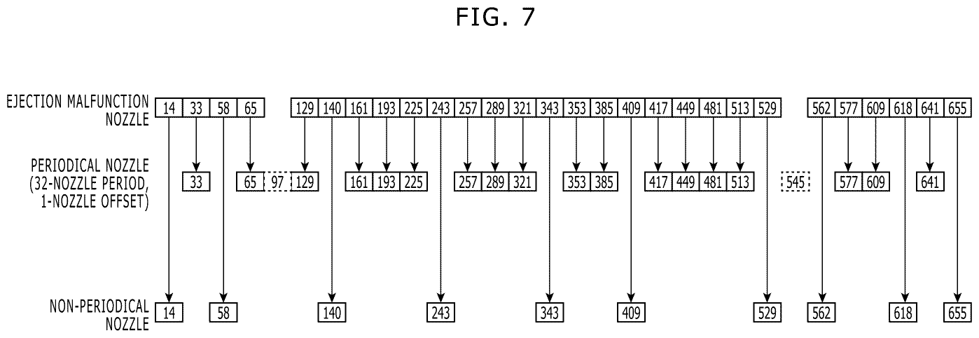

FIG. 7 shows a diagram that explains classification of the ejection malfunction nozzles shown in FIG. 6 into periodical nozzles and non-periodical nozzles. As shown in FIG. 7, for example, ejection malfunction nozzles included in plural nozzles specified by a specific period (32 nozzles in FIG. 7) and an offset (1 nozzle in FIG. 7) are determined as periodical nozzles, and the other ejection malfunction nozzles are determined as non-periodical nozzles.

Further, for the periodical nozzles, the ejection malfunction nozzle detecting unit 83 stores the specific period and the offset as the ejection malfunction nozzle data into the storage device 73 (in Step S5); and for the non-periodical nozzles, the ejection malfunction nozzle detecting unit 83 stores nozzle numbers of the non-periodical nozzles as the ejection malfunction nozzle data into the storage device 73 (in Step S6).

As mentioned, the ejection malfunction nozzles as targets of the correction process are determined, and the ejection malfunction nozzle data is stored into the storage device 73.

Afterward, when receiving a print request from a user (in Step S7), the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this behavior, the correction processing unit 84 reads the aforementioned ejection malfunction nozzle data from the storage device 73 and determines ejection malfunction nozzles (periodical nozzles and non-periodical nozzles) prior to start of printing; and upon detecting a position of the print sheet by the line sensor 31, (a) determines respective nozzles corresponding to pixels in the aforementioned image, (b) determines pixels corresponding to the ejection malfunction nozzles in the aforementioned image, and performs the correction process for the pixels and adjacent pixels of them. Subsequently, the control unit 81 performs the aforementioned printing on the basis of the image data after the correction process.

Here, the correction processing unit 84 performs the correction process for all of plural nozzles specified by the specific period and the offset for the periodical nozzles. Therefore, among these plural nozzles, the correction process is also performed for a normal nozzle that is not an ejection malfunction nozzle (in FIG. 7, for nozzles of nozzle numbers 97 and 545).

As mentioned, in the aforementioned embodiment, the ejection malfunction nozzle detecting unit 83 detects ejection malfunction nozzles on the basis of a scanned image of a test pattern; classifies the detected ejection malfunction nozzles into periodical nozzles that periodically appear with a specific period in the primary scanning direction and non-periodical nozzles other than the periodical nozzles; for the periodical nozzles, stores the specific period and an offset as the ejection malfunction nozzle data into the storage device 73, and for the non-periodical nozzles, stores the ejection malfunction nozzle data that individually indicates positions of the non-periodical nozzles into the storage device 73. The correction processing unit 84 performs the correction process for the periodical nozzles on the basis of the specific period and the offset in the ejection malfunction nozzle data, and performs the correction process for the non-periodical nozzles on the basis of the positions of the non-periodical nozzles in the ejection malfunction nozzle data.

Consequently, the ejection malfunction nozzle data is stored in a relatively small storage capacity, and the correction process is properly performed for a large number of periodical malfunction nozzles.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink corresponding to an image to be printed, using arranged nozzles;
a control unit configured to determine nozzles corresponding to the image to be printed, correspondingly to a position of a print sheet, and cause the recording head to eject ink from the nozzles;
an ejection malfunction nozzle detecting unit configured to (a) print a test pattern on a print sheet using the recording head, and (b) detect ejection malfunction nozzles on the basis of a scanned image of the test pattern;
a storage device configured to store ejection malfunction nozzle data that indicates the detected ejection malfunction nozzles; and
a correction processing unit configured to perform a correction process corresponding to the ejection malfunction nozzles on the basis of the ejection malfunction nozzle data;
wherein the ejection malfunction nozzle detecting unit (a) classifies the ejection malfunction nozzles into periodical nozzles that periodically appear with a specific period in a primary scanning direction and non-periodical nozzles other than the periodical nozzles, (b1) for the periodical nozzles, stores the specific period and an offset as the ejection malfunction nozzle data into the storage device, and (b2) for the non-periodical nozzles, stores the ejection malfunction nozzle data that individually indicates positions of the non-periodical nozzles into the storage device; and
the correction processing unit performs the correction process for the periodical nozzles on the basis of the specific period and the offset in the ejection malfunction nozzle data, and performs the correction process for the non-periodical nozzles on the basis of the positions of the non-periodical nozzles in the ejection malfunction nozzle data.

2. The image forming apparatus according to claim 1, wherein the ejection malfunction nozzle detecting unit determines the periodical nozzles such that plural nozzles specified by the specific period and the offset include a predetermined rate or more of the periodical nozzles.

3. The image forming apparatus according to claim 2, wherein the correction processing unit performs the correction process for plural nozzles specified by the specific period and the offset regardless of whether the plural nozzles specified by the specific period and the offset include a nozzle other than the ejection malfunction nozzles or not, and thereby performs the correction process for the periodical nozzles.

4. The image forming apparatus according to claim 1, wherein the correction processing unit sets the ejection malfunction nozzles to be non ejection, and increases ink ejection amounts of nozzles of ejection positions adjacent to ejection positions of the ejection malfunction nozzles.
